(19) United States
(12) Patent Application Publication
(10) Pub. No.: US 2019/0034284 A1
(43) Pub. Date: Jan. 31, 2019

(54) SEQUENCING HOST I/O REQUESTS AND I/O SNAPSHOTS

(71) Applicant: HEWLETT PACKARD ENTERPRISE DEVELOPMENT LP, Houston, TX (US)

(72) Inventors: Taranisen Mohanta, Bangalore (IN); Leena Kotrabasappa Muddi, Bangalore (IN); Abhijith Umesh, Bangalore (IN); Ashish Kumar, Bangalore (IN)

(21) Appl. No.: 15/658,731

(22) Filed: Jul. 25, 2017

(51) Int. Cl. G06F 11/14; G06F 3/06

(52) U.S. Cl. CPC G06F 11/1451; G06F 3/065; G06F 3/0619; G06F 2201/84; G06F 11/1435; G06F 3/0665; G06F 11/1464; G06F 3/067

(57) ABSTRACT

An example computing system for sequencing host I/O requests and I/O snapshots is disclosed. The example disclosed herein comprises a processing circuitry coupled to a storage unit, a non-transitory storage medium, a policy repository, and a client SLA file, wherein the storage system comprises a plurality of LUNs. The example further comprises a non-transitory storage medium storing machine readable instructions to cause the processor circuitry to receive a host I/O request from a client device through a network; to receive a backup snapshot; to decide whether to perform first the host I/O request or the I/O snapshot movement based on a policy stored in the policy repository and the client SLA file; to determine an order of operations on which the sequence of execution of the host I/O request and the I/O snapshot movement is based; to retrieve a host I/O request data from the storage system based on the order of operations; to send the host I/O request data to the client device based on the order of operations; and to perform the I/O snapshot movement by storing the first backup snapshot in a LUN of the plurality of LUNs based on the order of operations.

### BACKGROUND

On the cloud and hyper converged or converged infrastructure, the demand for the number of snapshots are increasing rapidly. On top of the previous, the demand for meeting the Service Level Agreements (SLA) with the enterprise customers to retrieve large volumes of data in a point-in-time data availability manner, and simultaneously perform the point-in-time backup snapshots is a challenge.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 is a block diagram illustrating an example of a computing system to sequence host input/output (I/O) requests and I/O snapshots.

FIG. 2 is a block diagram illustrating an example of a system configuration with storage units and Logical Unit Numbers (LUNs).

FIG. 3 is a block diagram illustrating an example of a system configuration with LUNs and snapshots.

FIG. 4 is a block diagram illustrating an example of a system configuration with LUNs and snapshot per client device.

FIG. 5 is a block diagram illustrating an example of a system performing an I/O snapshot movement.

FIG. 6 is a flowchart of an example method for sequencing host I/O request and I/O snapshots.

FIG. 7 is a flowchart of an example method for performing an I/O snapshot movement.

FIG. 8 is a flowchart of another example method for sequencing host I/O request and I/O snapshots.

FIG. 9 is a block diagram illustrating another example of a computing system to sequence host I/O requests and I/O snapshots.

FIG. 10A is a flowchart of an example method to replicate I/O snapshots in a plurality of storage nodes.

FIG. 10B is a block diagram illustrating an example of a storage system to replicate I/O snapshots in a plurality of storage nodes.

FIG. 11 is a block diagram illustrating an example of a computing system to sequence host I/O requests and I/O snapshots.

### DETAILED DESCRIPTION

The following description is directed to various examples of the disclosure. The examples disclosed herein should not be interpreted, or otherwise used, as limiting the scope of the disclosure, including the claims. In addition, the following description has broad application, and the discussion of any example is meant only to be descriptive of that example, and not intended to indicate that the scope of the disclosure, including the claims, is limited to that example. In the foregoing description, numerous details are set forth to provide an understanding of the examples disclosed herein. However, it will be understood by those skilled in the art that the examples may be practiced without these details. While a limited number of examples have been disclosed, those skilled in the art will appreciate numerous modifications and variations therefrom. It is intended that the appended claims cover such modifications and variations as fall within the scope of the examples. Throughout the present disclosure, the terms “a” and “an” are intended to denote at least one of a particular element. In addition, as used herein, the term “includes” means includes but not limited to, the term “including” means including but not limited to. The term “based on” means based at least in part on.

On the cloud and hyper converged or converged infrastructure, the demand for the number of snapshots are increasing rapidly. On top of the previous, the demand for meeting the Service Level Agreements (SLA) with the enterprise customers to retrieve large volumes of data in a point-in-time data availability manner, and simultaneously perform the point-in-time backup snapshots is a challenge. The decision making of enterprises in whether to execute host I/O request (e.g., point-in-time data availability), or to perform the I/O snapshot movements; in order to minimize the internal I/O to achieve the point-in-time data may be key.

Throughout the present disclosure, specific terminology may be used. The “host I/O request” (and “host I/O data”) may be understood as the point in time request of data (and data) that a client device may ask the computer system to retrieve therefrom (e.g., an storage system). The data requested by the client device, may have different versions (e.g., different time versions). In an example, the client device may want to store weekday daily versions of the backup (e.g., Monday version, Tuesday version, Wednesday version, Thursday version, and Friday version), therefore storing five backup snapshots of the data. In another example, the client device may want to store monthly versions of the backup (e.g., from January version to December version), therefore storing twelve backup snapshots of the data. In further examples, the client device may want to store weekly versions, or a preset specific time versions. The different snapshots of the data may be stored in a Logical Unit Number (LUN). A LUN is a logical unit comprising at least part of the storage space of one or more storing units from the storage system. Once a LUN is full of snapshot data and an incoming new snapshot is required to be stored therein, the “I/O snapshot movement” may be performed. The I/O snapshot movement is the process to store an incoming snapshot to its corresponding LUN.

One example of the present disclosure provides a computer system to sequence host I/O requests and I/O snapshots. The computing system includes a processing circuitry and a non-transitory storage medium. The processing circuitry is coupled to a storage system, the non-transitory storage medium, a policy repository, and a SLA file. The storage system may comprise a plurality of LUNs. The non-transitory storage medium of the example, stores machine readable instructions to cause the processing circuitry to receive a host I/O request from a client device through a network; to receive a backup snapshot; to decide whether to perform first the host I/O request or the I/O snapshot movement based on a policy stored in the policy repository and the client SLA file; to determine an order of operations on which the sequence of execution of the host I/O request and the I/O snapshot movement is based; to retrieve a host I/O request data from the storage system based on the order of operations; to send the host I/O request data to the client device based on the order of operations; and to perform the I/O snapshot movement by storing the first backup snapshot in a LUN of the plurality of LUNs based on the order of operations.

Another example of the present disclosure provides a method for sequencing host I/O requests and I/O snapshots. The disclosed method receives a host I/O request and a backup snapshot, wherein the backup snapshot is to be stored in a LUN from the storage system through an I/O snapshot movement. The method further decides whether to perform first the host I/O request or the I/O snapshot movement based on a policy stored in the policy repository and the client SLA file. The method also determines an order of operations on which the sequence of execution of the host I/O request and the I/O snapshot movement is based. Based on the order of operations, the method may (1) retrieve a host I/O request data from the storage system and send the host I/O request data to the client device; or (2) perform the I/O snapshot movement.

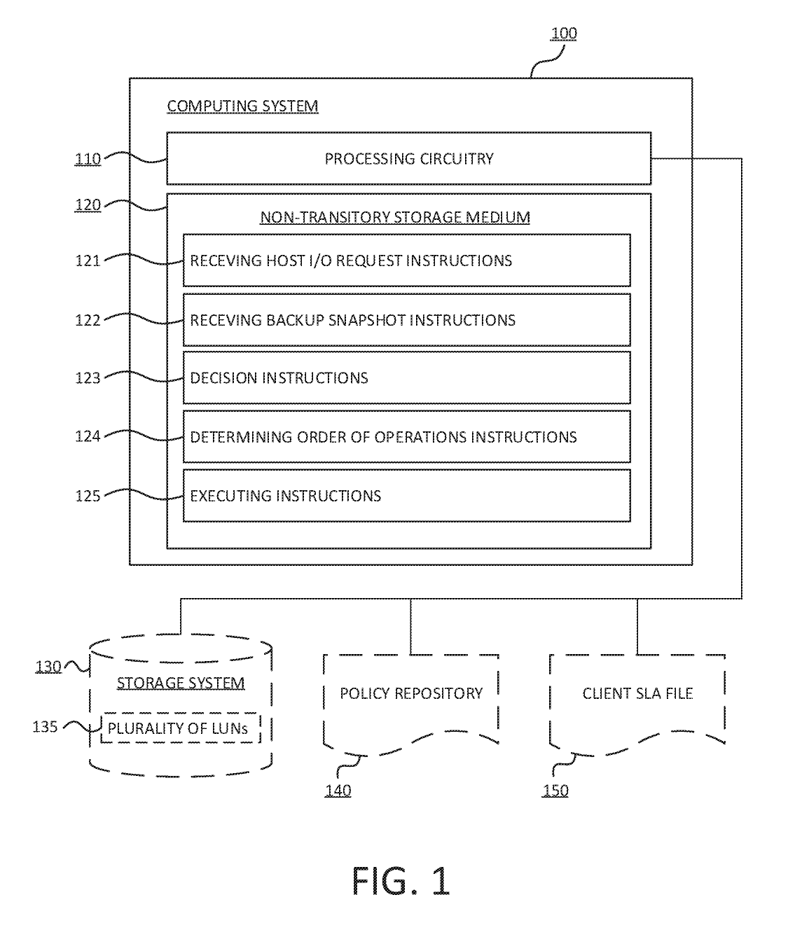

Now referring to the drawings, FIG. 1 is a block diagram illustrating an example of a computing system to sequence host I/O requests and I/O snapshots. The computing system 100 may comprise one or more processing units such as a CPU, a System on a Chip (SoC), a single processor, and the like. However, for clarity purposes the one or more processing units may be referred to as “the processing circuitry” hereinafter. The computing system 100 comprises the processing circuitry 110 and a non-transitory storage medium 120. The processing circuitry 110 is connected to a storage system 130, a policy repository 140, and a client SLA file 150. In another example of the present disclosure, the storage system 130, the policy repository 140, and the client SLA file 150 are part of the computing system 100. The non-transitory storage medium 120 stores machine readable instructions 121-125 that, when executed by the processing circuitry 110 cause the processing circuitry 110 to perform the functionality disclosed herein. The storage system 130 comprises a plurality of LUNs 135.

The non-transitory storage medium 120 comprises receiving host I/O request instructions 121, that when executed by the processing circuitry 110 cause the processing circuitry 110 to receive a host I/O request from a client device through the network. The medium 120 further comprises receiving backup snapshot instructions 122, to receive the backup snapshots to be stored in the appropriate LUNs from the plurality of LUNs 135 of the storage system 130.

The medium 120 further comprises decision instructions 123 that, when executed by the processing circuitry 110, cause the processing circuitry 110 to decide whether to perform first the host I/O request or the I/O snapshot movement based on a policy stored in the policy repository 140 and the client SLA file 150. The policy repository 140 may comprise one or more policies. Some examples of policies from the policy repository 140 may be: LUN priority, snapshot priority, dynamic priority, replication factor priority, and/or any other policy of interest to the client device. The LUN priority is a policy that indicates the priority or urgency per I/O snapshot movement to be performed; the dynamic priority is a policy that indicates the priority or urgency per I/O snapshot movement to be performed based on workload data prediction, and the replication factor priority may indicate in how many LUNs an I/O snapshot may be replicated. The client SLA file 150 comprises the Service Level Agreement (SLA) of the different clients that needs to be met. SLA include the minimum level of service that needs to be met since client devices send a host I/O request, until the system 100 sends the host I/O request data back to the client device.

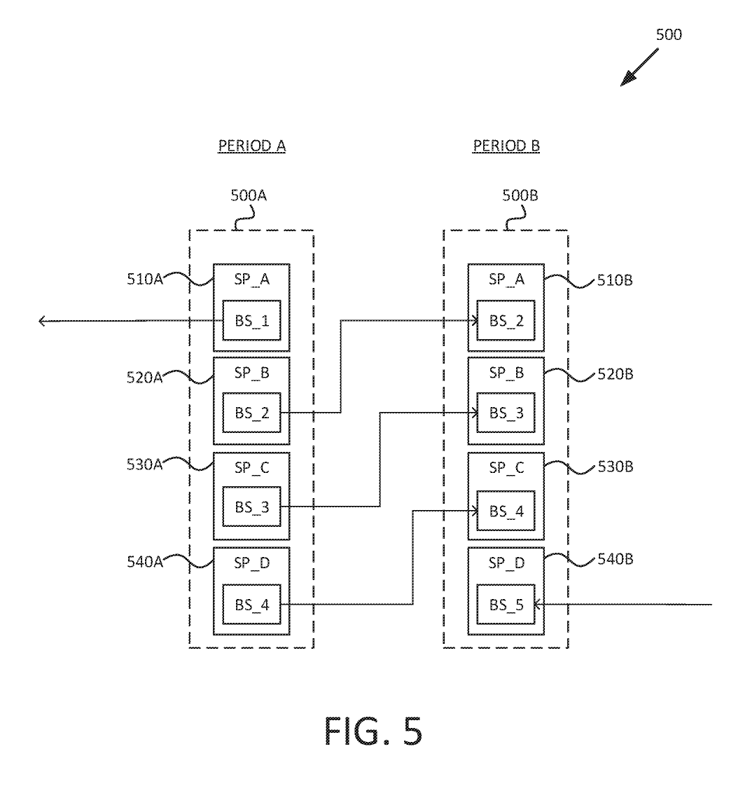

The non-transitory storage medium 120 comprises determining order of operations instructions that, when executed by the processing circuitry 110, cause the processing circuitry 110 to determine an order of operations on which the sequence of execution of the host I/O request and the I/O snapshot movement is based. The medium 120 further comprises executing instructions 125, that when executed by the processing circuitry 110, cause the processing circuitry 110 to perform actions based on the order of operations determined by the processing circuitry 110 by executing the determining order of operations instructions 124. In some examples, the processing circuitry 110 executes the executing instructions 125 by retrieving a host I/O request data from the storage system (e.g., if snapshot priority from the policy repository 140 is low). The processing circuitry 110 further sends the host I/O request data to the client device. In other examples, the processing circuitry 110 executes the executing instructions 125 by performing the I/O snapshot movement system (e.g., if snapshot priority from the policy repository 140 is high) by storing the first backup snapshot in a LUN of the plurality of LUNs 135. A detailed example of performing the snapshot movement is disclosed in FIG. 5 of the present disclosure.

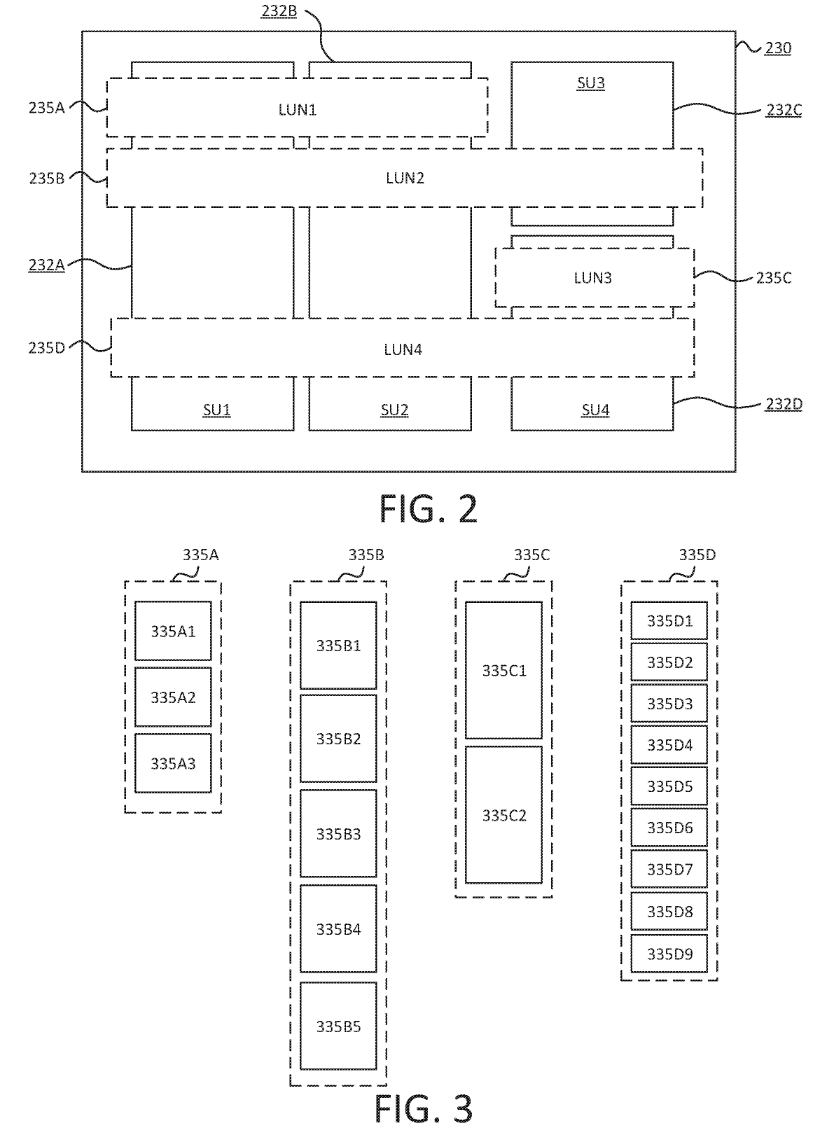

FIG. 2 is a block diagram illustrating an example of a system configuration with storage units and Logical Unit Numbers (LUNs). The storage system 230 may be similar or the same as the storage system 130 from FIG. 1. The storage system 230 comprises four storage units (SU): SU1 232A, SU2 232B, SU3 232C, and SU4 232D. The scope of the present disclosure includes any amount of storage units, however for clarity reasons, the example of FIG. 2 comprises only four storage units. Each storage unit (e.g., SU 232A-232D) may comprise a Hard Disk (HD), a Solid-State Drives (SSD), a Non-Volatile Memory (NVM), a Storage Area Network (SAN) arrays, and a combination thereof. Storage system 230 further comprises four LUNs: LUN1 235A, LUN2 235B, LUN3 235C, and LUN4 235D. The scope of the present disclosure includes any amount of LUNs, however for clarity reasons, the example of FIG. 2 comprises only four LUNs. FIG. 2 shows in solid lines physical elements (e.g., storage units); and in dotted lines virtual elements (e.g., LUNs).

LUNs are defined across the storage system. In the example of FIG. 2, LUN 1 235A is defined across storage units 232A, and 232B; LUN2 235B is defined across storage units 232A, 232B, and 232C; LUN3 is defined across storage unit 235C; and LUN 4 is defined across storage units 232A, 232B, and 232D. As it can be seen from the example, each LUN may comprise different storage extension and may be defined across a different number of storage units.

FIG. 3 is a block diagram illustrating an example of a system configuration with LUNs and snapshots. FIG. 3 comprises four LUNs: LUN1 335A, LUN2 335B, LUN3 335C, and LUN4 335D. LUNs 335A-335D may be the same or similar to LUNs 235A-235D from FIG. 2.

In the example of FIG. 3, LUN1 335A comprises three snapshots (335A1, 335A2, and 335A3); LUN2 335B comprises five snapshots (335B1, 335B2, 335B3, 335B4, and 335B5); LUN3 335C comprises two snapshots (335C1, and 335C2); and LUN4 comprises nine snapshots (335D1, 335D2, 335D3, 335D4, 335D5, 335D6, 335D7, 335D8, and 335D9). The example of FIG. 3 equates the size of the elements (e.g., size of each LUN 335A-335D, and size of the snapshots 335A1-335D9) to the size of their backup capacity; for example LUN1 335A is the smallest LUN, and LUN2 335B is the biggest LUN. As another example, the snapshots comprised in LUN3 335C (335C1-335C2) are the biggest snapshots, and the snapshots of LUN4 335D (335D1-335D9) are the smallest. Therefore, FIG. 3 shows that a first snapshot thread from a first LUN of the plurality of LUNs may comprise a different number of snapshots than a number of snapshots of a second snapshot thread from a second LUN of the plurality of LUNs.

Each LUN comprises a snapshot thread, wherein the snapshot thread comprises different versions of a backup. As a first example, LUN1 335A comprises three snapshots (335A1-335A3) in its snapshot thread; therefore snapshot 335A1 may comprise a first version of the data, snapshot 335A2 may comprise a second version of the data, and snapshot 335A3 may comprise a third version of the data. As a second example, LUN2 335B comprises five snapshots (335B1-335A5) in its snapshot thread; therefore snapshot 335B1 may comprise a first version of the data, snapshot 335B2 may comprise a second version of the data, snapshot 335B3 may comprise a third version of the data; snapshot 335B4 may comprise a fourth version of the data, and snapshot 335B5 may comprise a fifth version of the data. As a third example, LUN3 335C comprises two snapshots (335C1-335C2) in its snapshot thread; therefore snapshot 335C1 may comprise a first version of the data, and snapshot 335C2 may comprise a second version of the data. As a fourth example, LUN4 335D comprises nine snapshots (335D1-335D9) in its snapshot thread; therefore snapshot 335D1 may comprise a first version of the data, snapshot 335D2 may comprise a second version of the data, snapshot 335D3 may comprise a third version of the data; snapshot 335D4 may comprise a fourth version of the data, snapshot 335D5 may comprise a fifth version of the data, snapshot 335D6 may comprise a sixth version of the data, snapshot 335D7 may comprise a seventh version of the data, snapshot 335D8 may comprise an eighth version of the data, and snapshot 335D9 may comprise a ninth version of the data.

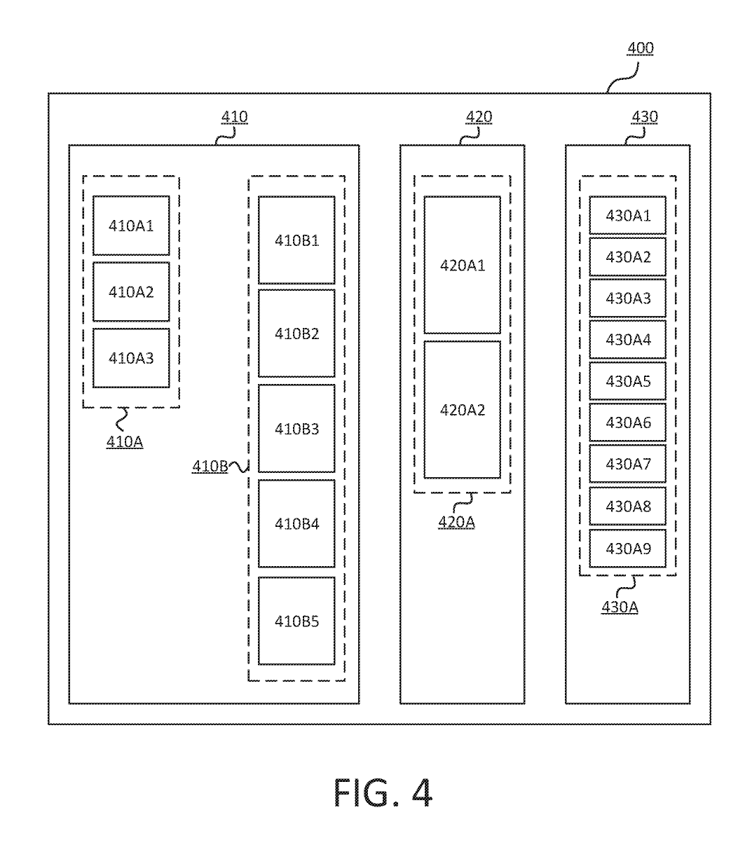

FIG. 4 is a block diagram illustrating an example of a system configuration with LUNs and snapshot per client device. System 400 comprises three client devices (CD): CD1 410, CD2 420, and CD3 430. System 400 further comprises four LUNs: LUN1 410A, LUN2 410B, LUN3 410C, and LUN4 410D. The scope of the present disclosure includes any amount of LUN and client devices, however for clarity reasons, the example of FIG. 4 comprises only three client devices and four LUNs. LUNs 410A-410B, 420A, and 430A may be similar or the same as LUNs 335A-335D from FIG. 3. LUN 1 410A comprises a snapshot thread with three snapshots (410A1, 410A2, 410A3); LUN2 410B comprises an snapshot thread with five snapshots (410B1, 410B2, 410B3, 410B4, 410B5); LUN3 420A comprises an snapshot thread with two snapshots (420A1, 420A2); and LUN4 430A comprises an snapshot thread with nine snapshots (430A1, 430A2, 430A3, 430A4, 430A5, 430A6, 430A7, 430A8, 430A9).

Each LUN from the plurality of LUNs contain snapshot threads of a backup information relating to a client device. In the example disclosed in FIG. 4, LUN1 410A contains three versions of a backup information relating to client device 1 410; LUN2 410B contains five versions of a backup information relating also to client device 1 410; LUN 3 420A contains two versions of a backup information relating to client device 2 420; and LUN4 430A contains nine versions of a backup information relating to client device 3 430. Therefore, as seen herein, each client device may be associated with one or more LUNs, wherein each LUN contain a snapshot thread with multiple versions of a backup information that may be further retrieved by the client device.

FIG. 5 is a block diagram illustrating an example of a system performing an I/O snapshot movement. The system 500 comprises a single LUN in two periods of time: LUN 500A in period A, and LUN 500B in period B. Period B is a time period after Period A. LUN 500A comprises an snapshot thread with four snapshot positions SP_A 510A, SP_B 520A, SP_C 530A, and SP_D 540A. LUN 500B comprises a snapshot thread with four snapshot positions SP_A 510B, SP_B 520B, SP_C 530B, and SP_D 540B. A snapshot position is a portion of the LUN wherein a snapshot may be stored therein. SP_A 510A from LUN 500A contains the oldest version of the backup information, referred hereinafter as the first (or oldest) backup snapshot BS_1; SP_B 520A contains the second backup snapshot BS_2; SP_C 530A contains the third backup snapshot BS_3: and SP_D 540A contains the forth backup snapshot BS_4 (newest version of the backup information at the end of Period A). Since the LUN has limited snapshot positions (e.g., four snapshot positions), and taken that at the end of the following period (Period B) a new snapshot (e.g., backup snapshot BS_5) needs to be stored in the LUN; a I/O snapshot movement needs to take place, to reorganize the backup snapshots within the LUN.

Once a new backup BS_5 arrives to the LUN 500B, the oldest backup snapshot (BS_1) is dropped (deleted). Then, all backup snapshots BS_2-BS_4 move to an older position: BS_2 moves from SP_B 520A to SP_A 510B, BS_3 moves from SP_C 530A to SP_B 5B0B; and BS_4 moves from SP_D 540A to SP_C 530B. Then, the new incoming backup BS_5 is stored in the newest snapshot position SP_D.

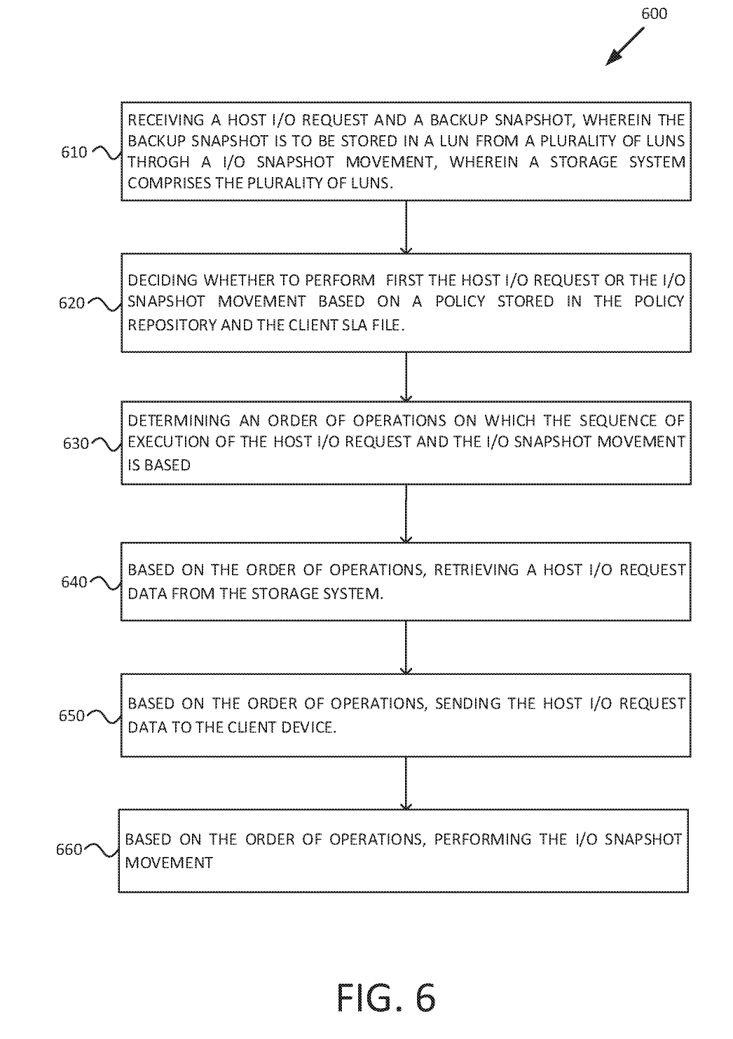

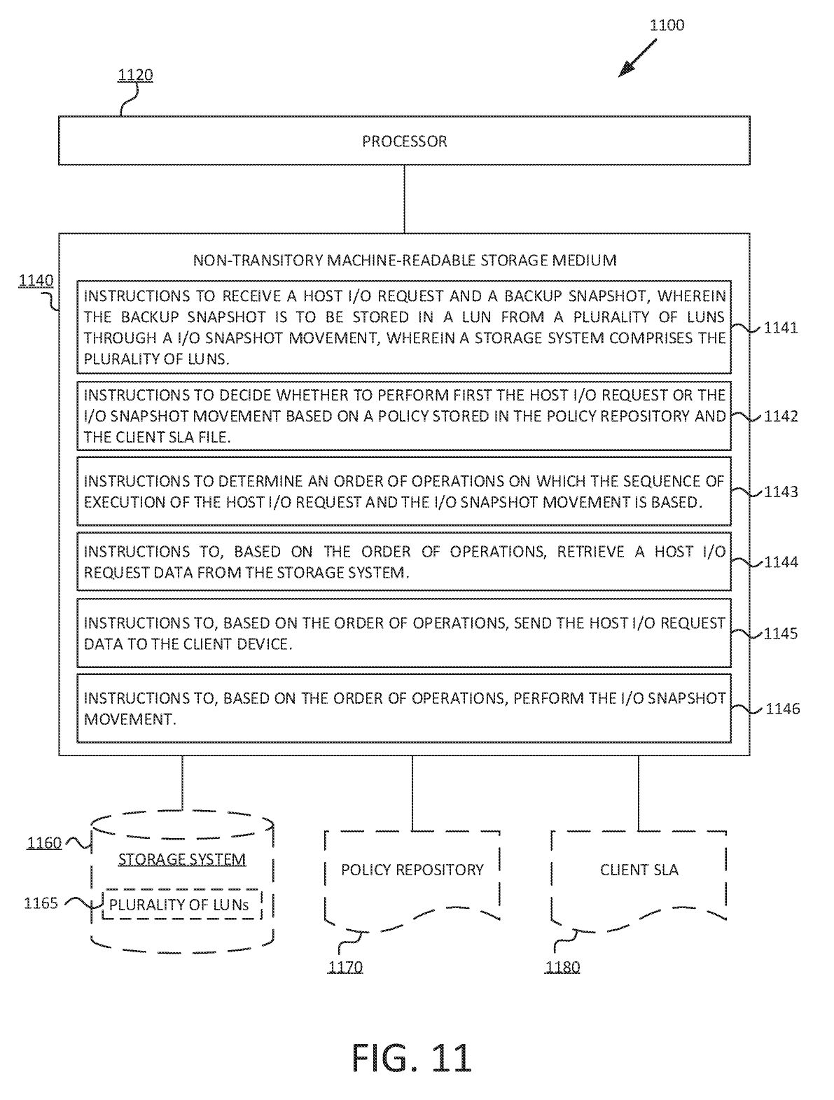

FIG. 6 is a flowchart of an example method for sequencing host I/O request and I/O snapshots. The method 600 may be performed by one or more processing units, such as CPU, SoC, processing circuitry, and the like. For clarity purposes, the at least one processing units may referred to as “a processor” or “the processor” hereinafter. Method 600 may be implemented, for example, by system 100 from FIG. 1. Method 600, as well as methods described herein can, for example, be implemented in the form of machine readable instructions stored on a memory of a computing system (e.g., implementation of instructions 1141-1146 of system 1100 from FIG. 11), in the form of electronic circuitry or another suitable form. The method 600 comprises a plurality of blocks (e.g., blocks 610-660) to be performed.

At block 610, the system (e.g., computing system 100 from FIG. 1) receives a host I/O request and a backup snapshot, wherein the backup snapshot is to be stored in a LUN from a plurality of LUNs (e.g., plurality of LUNs 135 from FIG. 1) through an I/O snapshot movement, and wherein a storage system (e.g., storage system 130 from FIG. 1) comprises said plurality of LUNs.

At block 620, the system decides whether to perform first the host I/O request or the I/O snapshot movement based on a policy stored in the policy repository (e.g., policy repository 140 from FIG. 1) and the client SLA file (e.g., client SLA file 150 from FIG. 1). In one example of the present disclosure, the system may decide whether to perform first the host I/O request or the I/O snapshot movement based on a workload data prediction, wherein the workload data prediction is based on historical data (e.g., statistical techniques, machine learning techniques, artificial intelligence techniques, and the like). In another example of the present disclosure, the system may comprise a policy within the policy repository that may prioritize the host I/O request or the I/O snapshot movement that comprises transferring a less volume of data.

At block 630, the system determines an order of operations on which the sequence of execution of the host I/O request and the I/O snapshot movement is based.

At block 640, the system retrieves a host I/O request data from the storage system based on the order of operations (e.g., order of operations determined at block 630).

At block 650, the system sends the host I/O request data to the client device based on the order of operations.

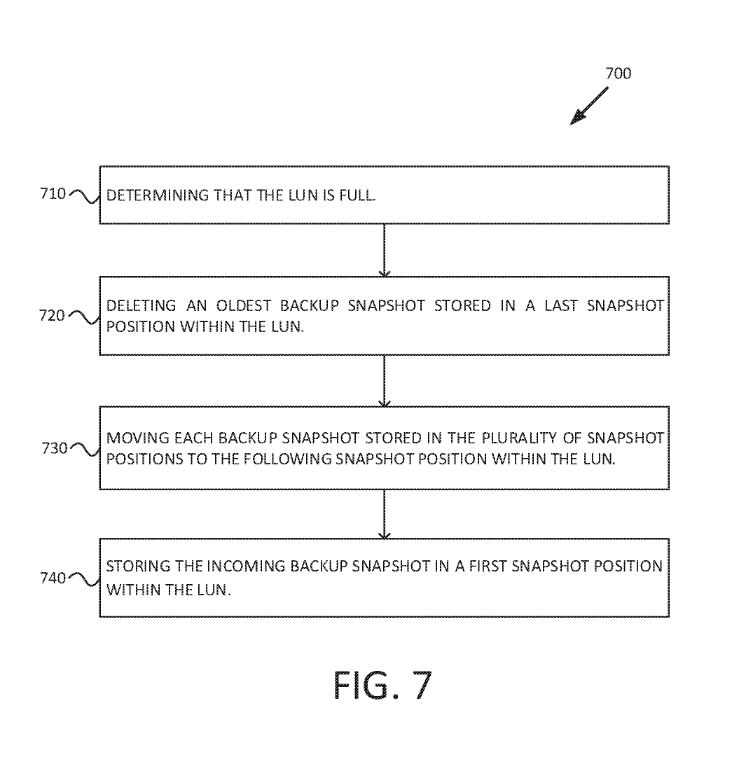

At block 660, the system performs the I/O snapshot movement (see, e.g., the I/O snapshot movement method 700 disclosed in FIG. 7) based on the order of operations.

FIG. 7 is a flowchart of an example method for performing an I/O snapshot movement. The method 700 may be performed by one or more processing units, such as CPU, SoC, processing circuitry, and the like. For clarity purposes, the at least one processing units may referred to as “a processor” or “the processor” hereinafter. Method 700 may be implemented, for example, by system 100 from FIG. 1, or by system 500 from FIG. 5. Method 700 may be an example of block 660 from FIG. 6. Method 700, as well as methods described herein can, for example, be implemented in the form of machine readable instructions stored on a memory of a computing system (e.g., implementation of instructions 1141-1146 of system 1100 from FIG. 11), in the form of electronic circuitry or another suitable form. The method 700 comprises a plurality of blocks (e.g., blocks 710-740) to be performed.

At block 710, the system (e.g., system 100 from FIG. 1, system 500 from FIG. 5) may determine that the LUN if full (e.g., by checking that all the snapshot positions 510A-540A from the snapshot thread of a LUN 500A contain a backup snapshot BS_1-BS_4 stored therein.

At block 720, the system may delete an oldest backup snapshot (e.g., backup snapshot BS_1 of FIG. 5) stored in a last snapshot position within the LUN (e.g., snapshot position SP_A 510A from LUN 500A from FIG. 5).

At block 730, the system may move each backup snapshot stored in the plurality of snapshot positions to the following snapshot position within the LUN (e.g., FIG. 5 BS_2 from SP_B 520A to SP_A 510B, BS_3 from SP_C 530A to SP_B 520B, and BS_4 from SP_D 540A to SP_C 530B). In one example of the present disclosure, the system may move each backup snapshot to an older snapshot position within LUN by first dividing each backup snapshot into a plurality of snapshot pages, wherein each snapshot page of the plurality of snapshot pages comprises less data than the backup snapshot. In an example, a backup snapshot may comprise an amount of data of the order of Gigabytes or Terabytes, however its snapshot pages may comprise an amount of data of the order of Megabytes (e.g., 4 Mb). Once the backup snapshot to be moved from snapshot position is divided into a plurality of snapshot pages, the system may move the snapshot pages from the snapshot position within the LUN.

At block 740, the system may store the incoming backup snapshot (e.g., BU_5 from FIG. 5) in a first snapshot position (e.g, SP_D 540B from FIG. 5) within the LUN.

For clarity purposes method 700 discloses a single I/O snapshot movement, however, a plurality of I/O snapshot movements may be performed substantially simultaneously (e.g., each I/O snapshot movement performing method 700 in parallel via a plurality of LUNs).

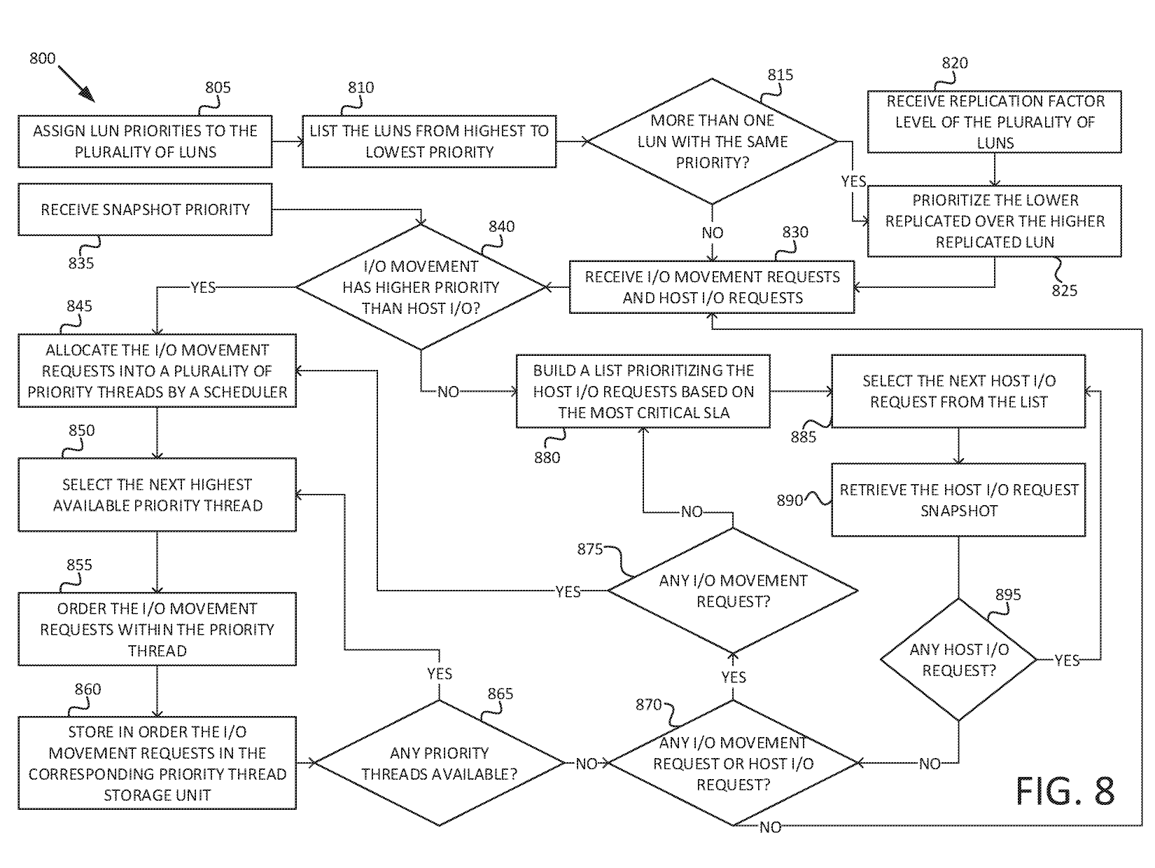

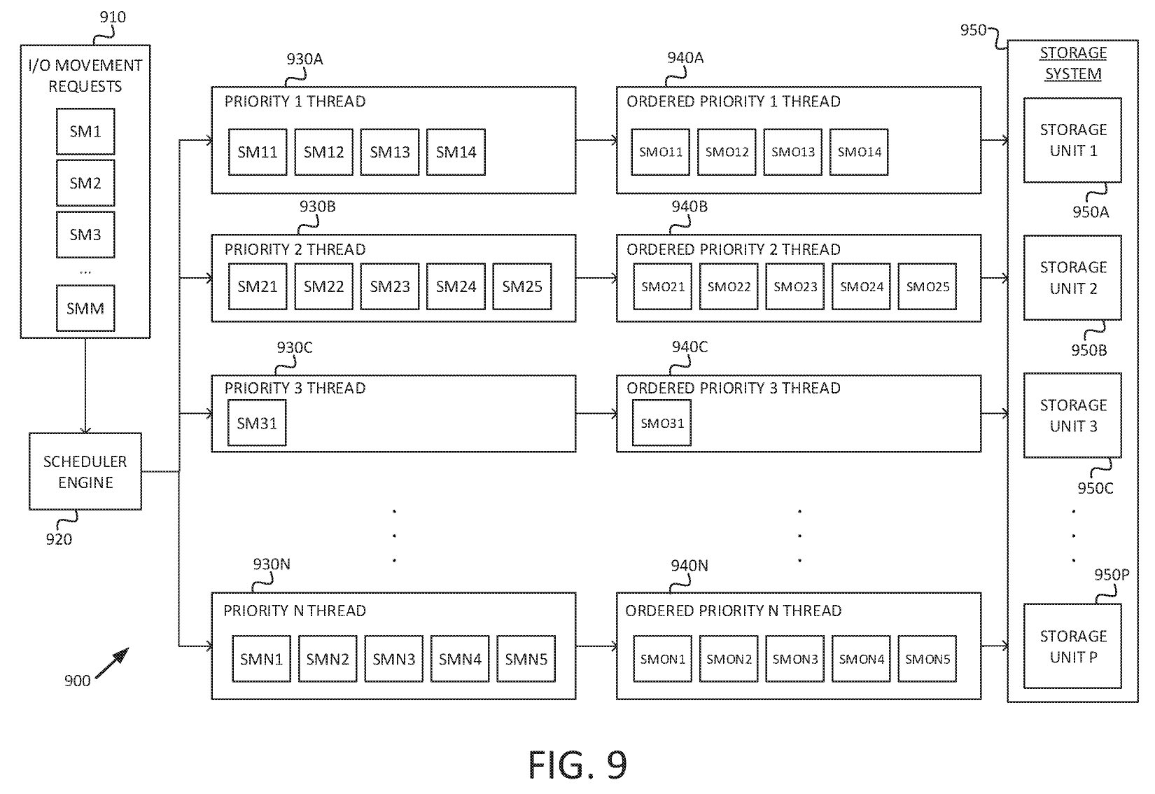

FIG. 8 is a flowchart of another example method for sequencing host I/O request and I/O snapshots. Method 800 may be performed by one or more processing units such as a CPU, a SoC, a single processor, a processing circuitry and the like. For clarity purposes, the at least one processing units may be referred hereinafter to as “a processor” or “the processor” hereinafter. Method 800 may have access to a storage system comprising a plurality of LUNs, a policy repository, and a client SLA file. The storage system may be similar or the same as the storage system 130 from FIG. 1, and the storage system 230 from FIG. 2. The plurality of LUNs may be similar or the same as the plurality of LUNs 135 from FIG. 1. The client SLA file may be similar or the same as SLA file 150 from FIG. 1. Method 800 may be implemented, for example, by system 100 from FIG. 1. Method 800 may also be implemented, for example, by system 900 from FIG. 9. Method 800 as well as the methods described herein can, for example, be implemented in the form of machine readable instructions stored on a memory of a computing system (e.g., implementation of instructions 1141-1146 of system 1100 from FIG. 11), in the form of electronic circuitry or another suitable form. The method 900 comprises a plurality of blocks to be performed.

At block 805, the system (e.g., system 100 of FIG. 1, system 900 of FIG. 9) may assign LUN priorities to the plurality of LUNs. The LUN plurality assignment may be based on a policy stored in the policy repository (e.g., policy repository 140 from FIG. 1). Then, at block 810, the system may list the LUNs from highest to lowest LUN priority. Then, at decision block 815, the system may determine whether there are more than one LUN with the same LUN priority.

At block 820, the system may receive a replication factor level of the plurality of LUNs. If, at decision block 815 it was determined that there are more than one LUN with the same LUN priority (YES branch from decision block 815), the system may prioritize the lower replicated over the higher replicated LUN (block 825) to have the complete list.

Regardless the system determined at the decision block 815 that there were not more than one LUN with the same priority (NO branch from decision block 815) or completing the list by performing block 825, the system may perform block 830 by receiving I/O movement requests and host I/O requests. Then, decision block 840 may be performed.

The system may receive at block 835 a snapshot priority. The snapshot priority may be retrieved from a policy included in the policy repository. At decision block 840, the system checks if the I/O movements have higher priority than the host I/O, based on the snapshot priority. If the system determines that the I/O movement has higher priority than the host I/O (YES branch from decision block 840), then block 845 may be performed. If the system determines that the I/O movement does not have higher priority than the I/O movement (NO branch from decision block 840), then block 880 is performed.

At block 845, the system may allocate (see, e.g., by scheduler 920 from FIG. 9) each incoming snapshot of the plurality of incoming snapshots in a corresponding priority thread (e.g., priority threads 930A-930N from FIG. 9) based on the LUN priority. Then, at block 850, the system may select the highest (or next highest) available priority thread, and may order (block 855) the I/O movement requests within the priority thread (see, e.g., ordered priority threads 940A-940N). Then, the system may perform block 860 by storing in order the I/O movement requests in the corresponding priority thread storage unit. Then, the system determines in decision block 865 whether there are any priority threads available. If there are more priority threads available (YES branch of decision block 865), then the system may perform block 850. If there are not more priority threads available (NO branch of decision block 865), then decision block 870 may be performed.

At block 880, the system may build a list prioritizing the host I/O requests based on the most critical SLA within the client SLA file. Then, at block 885, the system may select the next host I/O request from the list and retrieve (block 890) the host I/O request snapshot from the storage system. Once the host I/O request has been retrieved, the system may perform decision block 895 by determining whether there is any unsatisfied host I/O request. If the system determines that there is an unsatisfied host I/O request (YES branch from decision block 895), then block 885 may be performed. If the system determines that there is not any unsatisfied host I/O request (NO branch from decision block 895), then decision block 870 may be performed.

At decision block 870, the system may determine whether there is any unsatisfied I/O movement request or host I/O request. If the system determines that there is not any unsatisfied I/O movement request or host I/O request (NO branch from decision block 870), then block 830 may be performed. If the system determines that there is either an unsatisfied I/O movement request or host I/O request (YES branch from decision block 870), then decision block 875 may be performed.

At decision block 875, the system may determine whether there is any unsatisfied I/O movement request. If the system determines that there is at least one unsatisfied I/O movement request (YES branch from decision block 875), then block 845 may be performed. If the system determined that there is not any unsatisfied I/O movement request (NO branch from decision block 875), then block 880 may be performed.

In an example of the present disclosure, if there is any change is the client SLA file, or in the policy within the policy repository, the system may start over method 800.

FIG. 9 is a block diagram illustrating another example of a computing system to sequence host I/O requests and I/O snapshots. System 900 may be similar or the same to system 100 from FIG. 1. System 900 may perform method 600 from FIG. 6. System 900 may perform method 800 from FIG. 8.

System 900 may comprise a queue of I/O movement requests 910. The I/O movement requests 910 may comprise a plurality of snapshot movements: a first snapshot movement request SM1, a second snapshot movement request SM2, up to an Mth snapshot movement request SMM, wherein M is a positive integer. The snapshot movement requests may be sent to the I/O movement requests queue 910 by the system (e.g., system performing block 830 from FIG. 8).

The queue of I/O movement requests 910 may be coupled to a scheduler engine 920. The scheduler engine 920 may allocate (e.g., by performing block 845 from FIG. 8) each snapshot movement request (e.g., SM1-SMM) to its corresponding priority thread based on its LUN priority. The system 900 may comprise N priority threads in descendent order of priority: the highest priority 1 thread 930A, the priority 2 thread 930B, the priority 3 thread 930C, up to the lowest priority N thread 930N, wherein N is a positive integer. In an example, the scheduler engine 920 allocated SM11, SM12, SM13 and SM14 in priority 1 thread 930A; SM21, SM22, SM23, SM24, and SM25 in priority 2 thread 930B; SM31 in priority 3 thread 930C; up to SMN1, SMN2, SMn3, SMN4, and SMN5 in priority N thread 930N. The scheduler engine 920 may have allocated the previous snapshot movement requests (SM) in sequential order received by the I/O movement requests queue 910.

Each of the priority threads (e.g., priority thread 930A-930N) may be coupled to an ordered priority thread. For example, priority 1 thread 930A may be coupled to an ordered priority 1 thread 940A, priority 2 thread 930B may be coupled to an ordered priority 2 thread 940B; priority 3 thread 930C may be coupled to an ordered priority 3 thread 940C, and priority N thread 930N may be coupled to an ordered priority N thread 940N. The ordered priority threads (e.g., ordered priority threads 940A-940N) may contain the snapshot movements from the priority threads 930A-930N sorted in a more refined priority order (e.g., by performing block 855 from FIG. 8). For example, the snapshots movement requests SM11-SM14 from the priority 1 thread 930A are sorted into ordered snapshot movements SMO11-SMO14, wherein SMO11 is the snapshot movement request of the highest priority among SMO11-SMO14 and SMO14 is the snapshot movement request of the lowest priority among SMO11-SMO14; the snapshots movement requests SM21-SM25 from the priority 2 thread 930B are sorted into ordered snapshot movements SMO21-SMO25, wherein SMO21 is the snapshot movement request of the highest priority among SMO11-SMO25 and SMO25 is the snapshot movement request of the lowest priority among SMO11-SMO25; the snapshot movement request SS31 from priority 3 thread 930C is redefined as SMO31; and the snapshots movement requests SMN1-SMN5 from the priority N thread 930N are sorted into ordered snapshot movements SMON1-SMON5, wherein SMON1 is the snapshot movement request of the highest priority among SMON1-SMON5 and SMON5 is the snapshot movement request of the lowest priority among SMON1-SMON5.

Each ordered priority thread 940A-940N is coupled to the storage system 950. The storage system 950 may be similar or the same as the storage system 130 from FIG. 1, and the storage system 230 from FIG. 2. The storage system comprises a plurality of storage units (e.g., storage unit 1, storage unit 2, up to storage unit P; wherein P is a positive integer). In an example of the present disclosure, the storage system further comprises a plurality of LUNs (e.g., plurality of LUNs 135 from FIG. 1, plurality of LUNs 235A-235D from FIG. 2), the snapshot movements to be stored therein. The ordered snapshot movements are to be stored in the storage system (e.g., by performing block 860 from FIG. 8). The snapshot movements may be performed in the same or similar way as the I/O snapshot movement method 700 from FIG. 7.

In one example of the present disclosure, the I/O movement requests queue 910, the priority threads 930A-930N, and the ordered priority threads 940A-940N are buffers. In another example of the present disclosure, the priority threads 930A-930N and the ordered priority threads 940A-940N comprise the same buffers (e.g., priority 1 thread 930A and ordered priority 1 thread 940 are the same buffer, up to priority N thread 930N and ordered priority N thread 940N are the same buffer). In another example of the present disclosure, the priority threads 930A-930N and the ordered priority threads 940A-940N comprise different buffers (e.g., priority 1 thread 930A and ordered priority 1 thread 940 are not the same buffer, up to priority N thread 930N and ordered priority N thread 940N are not the same buffer).

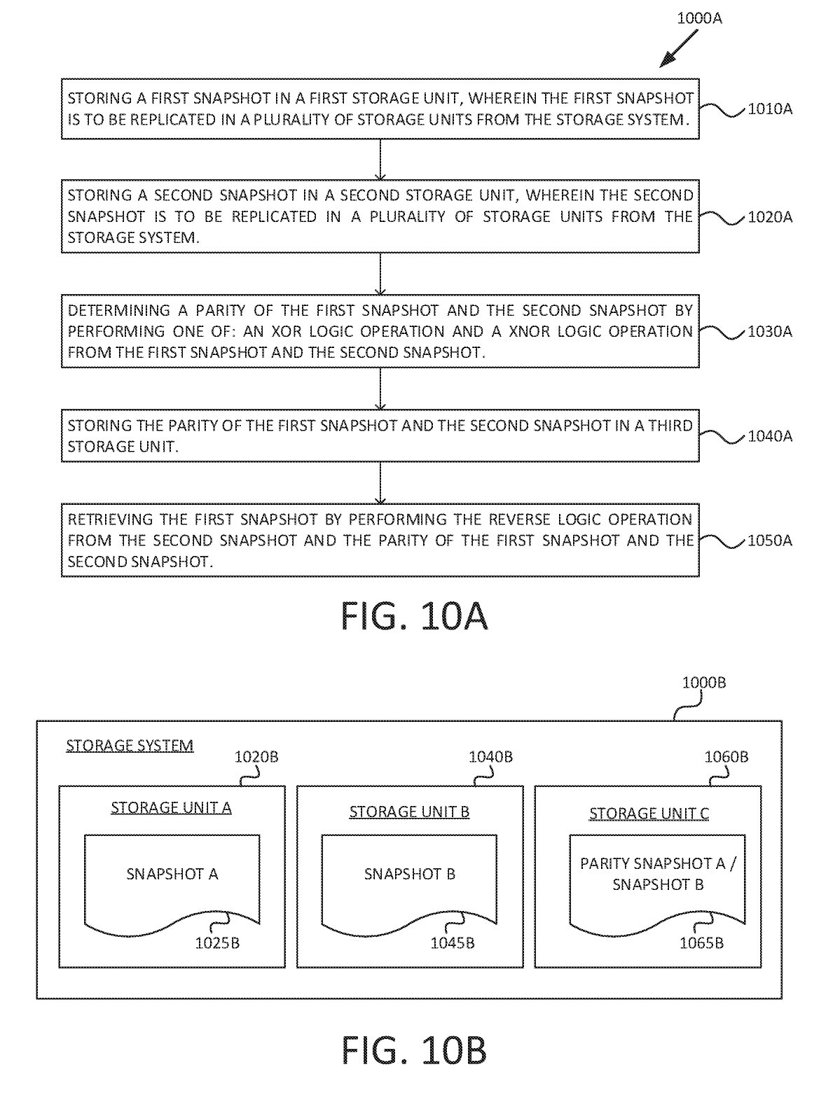

FIG. 10A is a flowchart of an example method to replicate I/O snapshots in a plurality of storage nodes. The method 1000A may be performed by one or more processing units, such as CPU, SoC, processing circuitry, and the like. For clarity purposes, the at least one processing units may referred to as “a processor” or “the processor” hereinafter. Method 1000A may be implemented, for example, by system 100 from FIG. 1, system 230 from FIG. 2, or by system 1000B from FIG. 10B. Method 700, as well as methods described herein can, for example, be implemented in the form of machine readable instructions stored on a memory of a computing system (e.g., implementation of instructions 1141-1146 of system 1100 from FIG. 11), in the form of electronic circuitry or another suitable form. The method 1000A comprises a plurality of blocks (e.g., blocks 1010A-1050A) to be performed.

At block 1010A, the system (e.g., system 100 from FIG. 1, system 230 from FIG. 2, system 1000B from FIG. 10B) may store a first snapshot in a first storage unit (see, e.g., snapshot A 1025B in storage unit A 1020B from FIG. 10B), wherein the first snapshot is to be replicated in a plurality of storage units from the storage system (e.g., replicated in storage unit C 1060B from storage system 1000B from FIG. 10B).

At block 1020A, the system may store a second snapshot in a second storage unit (see, e.g., snapshot B 1045B in storage unit B 1040B from FIG. 10B), wherein the second snapshot is to be replicated in a plurality of storage units from the storage system (e.g., replicated in storage unit C 1060B from storage system 1000B from FIG. 10B).

At block 1030A, the system may determine a parity of the first snapshot and the second snapshot (e.g., parity snapshot A/snapshot B 1065B from FIG. 10B) by performing one of: an XOR logic operation and a XNOR logic operation from the first snapshot and the second snapshot.

At block 1040A, the system may store the parity of the first snapshot and the second snapshot in a third storage unit (e.g., storage unit C 1060B from FIG. 10B).

At block 1050A, the system may retrieve the first snapshot (e.g., snapshot A 1025B from FIG. 10B) by performing the reverse logic operation performed in block 1030A (XNOR in the case XOR was performed at block 1030A, and XOR in the case XNOR was performed at block 1030A) from the second snapshot (e.g., snapshot B 1045B from FIG. 10B) and the parity of the first snapshot and the second snapshot (e.g., parity snapshot A/snapshot B 1065B from FIG. 10B).

FIG. 10B is a block diagram illustrating an example of a storage system to replicate I/O snapshots in a plurality of storage nodes. The storage system 1000B may be similar or the same as the storage system 130 from FIG. 1. The storage system 1000B may be similar or the same as the storage system 230 from FIG. 2. Storage system 1000B may perform method 1000A from FIG. 10A. The storage system 1000B may comprise a plurality of storage units. For clarity purposes, only three storage units are shown, however the scope of the present disclosure may include more or less storage units. Storage system 1000B may comprise storage unit A 1020B, storage unit B 1040B, and storage unit C 1060B. Storage unit A 1020B may store snapshot A 1025B, storage unit B 1040B may store snapshot B 1045B, and storage unit C 1060C may store the parity of snapshot A and snapshot B 1065B.

FIG. 11 is a block diagram illustrating an example of a computing system to sequence host I/O requests and I/O snapshots. FIG. 11 describes a system 1100 that includes a physical processor 1120 and a non-transitory machine-readable storage medium 1140. The processor 1120 may be a microcontroller, a microprocessor, a central processing unit (CPU) core, an application-specific-integrated circuit (ASIC), a field programmable gate array (FPGA), and/or the like. The machine-readable storage medium 1140 may store or be encoded with instructions 1141-1146 that may be executed by the processor 1120 to perform the functionality described herein. System 1100 hardware may be the same or similar as the hardware in system 100 of FIG. 1. System 1100 may use the method 600 of FIG. 6. System 1100 may use the method 800 of FIG. 8. System 1100 may be connected to a storage system 1160. The storage system 1160 may be the same or similar as the storage system 130 from FIG. 1, or the storage system 230 from FIG. 2. The storage system 1160 may comprise a plurality of LUNs 1165. The plurality of LUNs 1165 may be the same or similar as the plurality of LUNs 135 from FIG. 1. System 1100 may be further connected to a policy repository 1170. The policy repository 1170 may be the same or similar as the policy repository 140 from FIG. 1. System 600 may be further connected to a client SLA file 1180. The client SLA file 1180 may be the same or similar to the client SLA file 150 from FIG. 1.

In an example, the instructions 1141-1146, and/or other instructions can be part of an installation package that can be executed by the processor 1120 to implement the functionality described herein. In such case, non-transitory machine readable storage medium 1140 may be a portable medium such as a CD, DVD, or flash device or a memory maintained by a computing device from which the installation package can be downloaded and installed. In another example, the program instructions may be part of an application or applications already installed in the non-transitory machine-readable storage medium 1140.

The non-transitory machine readable storage medium 1140 may be an electronic, magnetic, optical, or other physical storage device that contains or stores executable data accessible to the system 1100. Thus, non-transitory machine readable storage medium 1140 may be, for example, a Random Access Memory (RAM), an Electrically Erasable Programmable Read-Only Memory (EEPROM), a storage device, an optical disk, and the like. The non-transitory machine readable storage medium 1140 does not encompass transitory propagating signals. Non-transitory machine readable storage medium 1140 may be allocated in the system 1100 and/or in any other device in communication with system 1100.

In the example of FIG. 11, the instructions 1141, when executed by the processor 1120, cause the processor 1120 to receive a host I/O request and a backup snapshot, wherein the backup snapshot is to be stored in a LUN from a plurality of LUNs 1165 through a I/O snapshot movement, wherein a storage system 1160 comprises the plurality of LUNs 1165.

The system 1100 may further include instructions 1142 that, when executed by the processor 1120, cause the processor 1120 to decide whether to perform first the host I/O request or the I/O snapshot movement based on a policy stored in the policy repository and the client SLA file.

The system 1100 may further include instructions 1143 that, when executed by the processor 1120, cause the processor 1120 to determine an order of operations on which the sequence of execution of the host I/O request and the I/O snapshot movement is based.

The system 1100 may further include instructions 1144 that, when executed by the processor 1120, cause the processor 1120 to retrieve a host I/O request data from the storage system based on the order of operations.

The system 1100 may further include instructions 1145 that, when executed by the processor 1120, cause the processor 1120 to send the host I/O request data to the client device based on the order of operations.

The system 1100 may further include instructions 1146 that, when executed by the processor 1120, cause the processor 1120 to perform the I/O snapshot movement based on the order of operations.

The system 1100 may further include additional instructions that, when executed by the processor 1120, cause the processor 1120 to allocate, by a scheduler, each incoming snapshot of a plurality of incoming snapshots in a corresponding priority thread based on the LUN priority.

The system 1100 may further include additional instructions that, when executed by the processor 1120, cause the processor 1120 to sort the plurality of snapshots allocated in a first priority thread from highest to lowest LUN priority.

The system 1100 may further include additional instructions that, when executed by the processor 1120, cause the processor 1120 to store the plurality of snapshots allocated in the first priority thread in a corresponding storage unit, wherein the storage unit is part of the storage system.

The system 1100 may further include additional instructions that, when executed by the processor 1120, cause the processor 1120 to determine that a LUN is full.

The system 1100 may further include additional instructions that, when executed by the processor 1120, cause the processor 1120 to delete an oldest backup snapshot stored in a last snapshot position within the LUN.

The system 1100 may further include additional instructions that, when executed by the processor 1120, cause the processor 1120 to move each backup snapshot stored in the plurality of snapshot positions to the following snapshot position within the LUN.

The system 1100 may further include additional instructions that, when executed by the processor 1120, cause the processor 1120 to store the incoming backup snapshot in a first snapshot position within the LUN.

The system 1100 may further include additional instructions that, when executed by the processor 1120, cause the processor 1120 to store a first snapshot in a first storage unit, wherein the first snapshot is to be replicated in a plurality of storage units from the storage system.

The system 1100 may further include additional instructions that, when executed by the processor 1120, cause the processor 1120 to store a second snapshot in a second storage unit, wherein the second snapshot is to be replicated in a plurality of storage units from the storage system.

The system 1100 may further include additional instructions that, when executed by the processor 1120, cause the processor 1120 to determine a parity of the first snapshot and the second snapshot by performing one of: an XOR logic operation and an XNOR logic operation from the first snapshot and the second snapshot.

The system 1100 may further include additional instructions that, when executed by the processor 1120, cause the processor 1120 to store the parity of the first snapshot and the second snapshot in a third storage unit.

The system 1100 may further include additional instructions that, when executed by the processor 1120, cause the processor 1120 to retrieve the first snapshot by performing the reverse logic operation from the second snapshot and the parity of the first snapshot and the second snapshot.

The above examples may be implemented by hardware or software in combination with hardware. For example the various methods, processes and functional modules described herein may be implemented by a physical processor (the term processor is to be interpreted broadly to include CPU, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, methods and functional modules are implemented as machine readable instructions executable by at least one processor, hardware logic circuitry of the at least one processors, or a combination thereof.

The drawings in the examples of the present disclosure are some examples. It should be noted that some units and functions of the procedure are not necessarily essential for implementing the present disclosure. The units may be combined into one unit or further divided into multiple sub-units. What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

What it is claimed is:

1. A computer system comprising:
a processing circuitry coupled to a storage system, a non-transitory storage medium, a policy repository, and a client Service Level Agreement (SLA) file, wherein the storage system comprises a plurality of Logical Unit Numbers (LUN); and
the non-transitory storage medium storing machine readable instructions to cause the processor circuitry to:
receive a host input/output (I/O) request from a client device through a network;
receive a backup snapshot;
decide whether to perform first the host I/O request or the I/O snapshot movement based on a policy stored in the policy repository and the client SLA file;
determine an order of operations on which the sequence of execution of the host I/O request and the I/O snapshot movement is based;
based on the order of operations, retrieve a host I/O request data from the storage system;
based on the order of operations, send the host I/O request data to the client device; and
based on the order of operations, perform the I/O snapshot movement by storing the first backup snapshot in a LUN of the plurality of LUNs.

2. The system of claim 1, wherein the policy stored in the policy repository comprises at least one of: LUN priority, snapshot priority, dynamic priority, and replication factor priority.

3. The system of claim 2, wherein the backup snapshot is an incoming snapshot of a plurality of incoming snapshots, the system further comprising a plurality of priority threads and a scheduler, wherein the scheduler allocates each incoming snapshot of the plurality of incoming snapshots in the corresponding priority thread based on the LUN priority.

4. The system of claim 1, wherein the storage unit comprises a Hard Disk (HD), a Solid-State Drives (SSD), a Non Volatile Memory (NVM), a Storage Area Network (SAN) arrays, and a combination thereof.

5. The system of claim 1, wherein the LUN of the plurality of LUNs comprises a snapshot thread of different snapshot versions of a backup.

6. The system of claim 5, wherein a first snapshot thread from a first LUN of the plurality of LUNs comprises a different number of snapshots than a number of snapshots of a second snapshot thread from a second LUN of the plurality of LUNs.

7. The system of claim 5, wherein a LUN of the plurality of LUNs contains snapshot threads of backup information relating to a client device.

8. A method comprising:
receiving a host input/output (I/O) request and a backup snapshot, wherein the backup snapshot is to be stored in a Logical Unit Number (LUN) from a plurality of LUNs through a I/O snapshot movement, wherein a storage system comprises the plurality of LUNs;
deciding whether to perform first the host I/O request or the I/O snapshot movement based on a policy stored in the policy repository and the client Service Level Agreement (SLA) file;
determining an order of operations on which the sequence of execution of the host I/O request and the I/O snapshot movement is based;
based on the order of operations, retrieving a host I/O request data from the storage system,
based on the order of operations, sending the host I/O request data to the client device; and
based on the order of operations, performing the I/O snapshot movement.

9. The method of claim 8, wherein the policy comprises a LUN priority and a snapshot priority, wherein the backup snapshot is an incoming snapshot of a plurality of incoming snapshots, the method further comprising:
allocating, by a scheduler, each incoming snapshot of the plurality of incoming snapshots in a corresponding priority thread based on the LUN priority; and
storing the snapshots in a corresponding storage unit, wherein the storage unit is part of the storage system.

10. The method of claim 9, further comprising sorting a plurality of snapshots allocated to a first priority thread from highest to lowest LUN priority.

11. The method of claim 8, wherein the LUN comprises a plurality of snapshot positions to store different versions of a backup, wherein an incoming backup snapshot is to be stored in a LUN, wherein the I/O snapshot movement comprising:
determining that the LUN is full;
deleting an oldest backup snapshot stored in a last snapshot position within the LUN;
moving each backup snapshot stored in the plurality of snapshot positions to the following snapshot position within the LUN; and
storing the incoming backup snapshot in a first snapshot position within the LUN.

12. The method of claim 11, wherein a plurality of I/O snapshot movements may be performed substantially simultaneously.

13. The method of claim 11, wherein moving each backup snapshot to an older snapshot position within the LUN further comprising:
dividing each backup snapshot into a plurality of snapshot pages, wherein each snapshot page of the plurality of snapshot pages comprises less data than the backup snapshot; and
moving each snapshot page to an older snapshot position within the LUN.

14. The method of claim 8, wherein deciding whether to perform first the host I/O request or the I/O snapshot movement is based on a workload data prediction, and wherein the workload data prediction is based on historical data.

15. The method of claim 8, wherein the policy stored in the policy repository prioritize the host I/O request or the I/O snapshot movement that comprises transferring a less volume of data.

16. The method of claim 8, further comprising:
storing a first snapshot in a first storage unit, wherein the first snapshot is to be replicated in a plurality of storage units from the storage system;
storing a second snapshot in a second storage unit, wherein the second snapshot is to be replicated in a plurality of storage units from the storage system;
determining a parity of the first snapshot and the second snapshot by performing one of: an XOR logic operation and an XNOR logic operation from the first snapshot and the second snapshot;
storing the parity of the first snapshot and the second snapshot in a third storage unit; and
retrieving the first snapshot by performing the reverse logic operation from the second snapshot and the parity of the first snapshot and the second snapshot.

17. A non-transitory machine-readable medium storing machine-readable instructions executable by a physical processor, the physical processor causing the processor to:
receive a host input/output (I/O) request and a backup snapshot, wherein the backup snapshot is to be stored in a Logical Unit Number (LUN) from a plurality of LUNs through a I/O snapshot movement, wherein a storage system comprises the plurality of LUNs;
decide whether to perform first the host I/O request or the I/O snapshot movement based on a policy stored in the policy repository and the client Service Level Agreement (SLA) file;
determine an order of operations on which the sequence of execution of the host I/O request and the I/O snapshot movement is based;
based on the order of operations, retrieve a host I/O request data from the storage system;
based on the order of operations, send the host I/O request data to the client device; and
based on the order of operations, perform the I/O snapshot movement.

18. The non-transitory machine-readable medium of claim 17, wherein the policy comprises a LUN priority and a snapshot priority, wherein the backup snapshot is an incoming snapshot of a plurality of incoming snapshots, the medium further comprising machine readable instructions that are executable by the processor to:
allocate, by a scheduler, each incoming snapshot of a plurality of incoming snapshots in a corresponding priority thread based on the LUN priority;
sort the plurality of snapshots allocated in a first priority thread from highest to lowest LUN priority; and
store the plurality of snapshots allocated in the first priority thread in a corresponding storage unit, wherein the storage unit is part of the storage system.

19. The non-transitory machine-readable medium of claim 17, wherein the LUN comprises a plurality of snapshot positions to store different versions of a backup, wherein an incoming backup snapshot is to be stored in the LUN, the medium further comprising machine readable instructions that are executable by the processor to:
determine that the LUN is full;
delete an oldest backup snapshot stored in a last snapshot position within the LUN;
move each backup snapshot stored in the plurality of snapshot positions to the following snapshot position within the LUN; and;
store the incoming backup snapshot in a first snapshot position within the LUN.

20. The non-transitory machine-readable medium of claim 17, further comprising machine readable instructions that are executable by the processor to:
store a first snapshot in a first storage unit, wherein the first snapshot is to be replicated in a plurality of storage units from the storage system;
store a second snapshot in a second storage unit, wherein the second snapshot is to be replicated in a plurality of storage units from the storage system;
determine a parity of the first snapshot and the second snapshot by performing one of: an XOR logic operation and an XNOR logic operation from the first snapshot and the second snapshot;
store the parity of the first snapshot and the second snapshot in a third storage unit; and
retrieve the first snapshot by performing the reverse logic operation from the second snapshot and the parity of the first snapshot and the second snapshot.
